(19) United States
(12) Patent Application Publication
(10) Pub. No.: US 2019/0267639 A1
(43) Pub. Date: Aug. 29, 2019

(54) Battery Cells With Removable Elements

(71) Applicant: Mingrong Zhao, Ottawa (CA)

(72) Inventor: Mingrong Zhao, Ottawa (CA)

(21) Appl. No.: 15/908,797

(22) Filed: Feb. 28, 2018

(51) Int. Cl. H01M 6/50; H01M 2/04

(52) U.S. Cl. CPC H01M 6/505; H01M 2/04

(57) ABSTRACT

A battery cell includes a generally battery cell and removable elements which providing a function for battery users to mark the battery status of used or dead.

### CROSS-REFERENCE TO RELATED APPLICATIONS

The present Application claims priority to provisional patent application number U.S. 62/461,343, filed on Feb. 21, 2017 and provisional patent application number U.S. 62/470,294, filed on Mar. 12, 2017.

### BACKGROUND OF THE INVENTION

### 1. Field of the Invention

The present invention is in the field of battery cells and labels.

### 2. Description of Related Art

There are hundreds patents published related to battery cells. Most of them focus on quality and effectiveness. Few of them addressed to customer experience. None of them made effort on dead battery cells to help battery users distinguish it from good battery.

### BRIEF SUMMARY OF THE INVENTION

Nowadays, the battery cells have very high quality. They will keep its brand new appearances after they are actually dead inside for a long time. This caused a lot of confusions and problems in our daily life. The present invention has been made in view of the above-mentioned problem, and it is an object of the present invention to provide an improvement by which a battery cell will be combined with a removable element for battery users to mark a dead battery and avoid having difficulty to distinguish bad battery cell from good one.

### BRIEF DESCRIPTION OF THE SEVERAL VIEWS OF THE DRAWINGS

FIG. 1 is a single-view drawing of an embodiment having removable elements extended from a battery jacket on a top of a cap.

FIG. 2 is a single-view drawing of an embodiment having a part of battery jacket as a removable element on a top of a cap.

FIG. 3 is a single-view drawing of an embodiment having a removable element extended from a straight ending edge of a battery jacket.

FIG. 4 is a single-view drawing of an embodiment having a removable element which is a part of a battery jacket.

FIG. 5 is a single-view drawing of an embodiment having a shorter removable element extended from a straight ending edge of a battery jacket.

FIG. 6 is a single-view drawing of an embodiment having a removable element which is adhered on a top of a battery jacket.

FIG. 7 is a single-view drawing of an embodiment having a removable element which is adhered on a top of a cap.

### DETAILED DESCRIPTION OF THE INVENTION

The inventor provides an improvement of battery cells. One or more than one removable element is provided on a surface of battery cell by manufactories. Those element can be torn off; peeled off or scratched off by battery users. Battery users are able to use those removable elements to directly mark a battery dead or used without limitation of requiring further assistance from other articles, such like a tape; a marker or a designated container. The present invention is described in enabling detail in the following examples, which may represent more than one embodiment of the present invention.

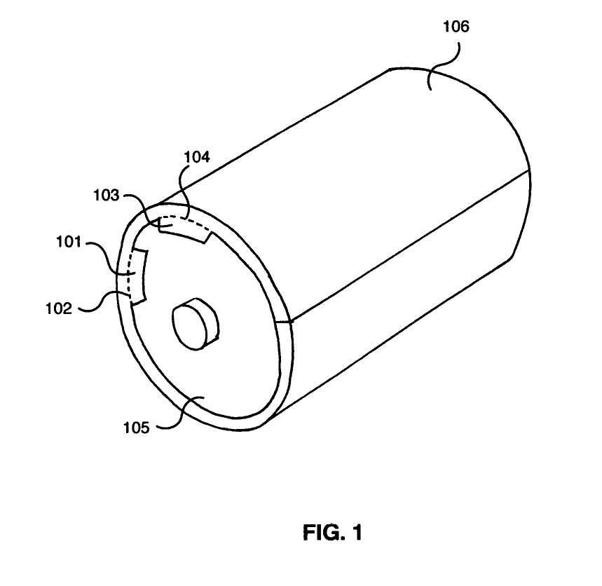

FIG. 1 is a single-view drawing according to an embodiment of the present invention. It comprises a generally battery cell and at least one of removable element. A generally battery cell in this example comprising a battery tube which is inside and not visible from outside; a positive cap 105 on the left side of battery tube; a negative cap on the right side of battery tube which is invisible; a battery jacket 106 coating on the top of battery tube and parts of both caps. Removable Element 101 is in this example extended part of battery jacket 106 on the top of positive cap 105.

Removable Element 101 is in this example easy to be torn off by battery users along Dotted Line 102 to mark a status of battery cell. Ideally there is text information showed around Dotted Line 102 to instruct battery users how to use it. After Removable Element 101 is removed, another text information originally covered by Removable Element 101 will be visible to inform that battery cell is in this example used. Removable Element 103 and Dotted Line 104 is in this example is for marking status of dead.

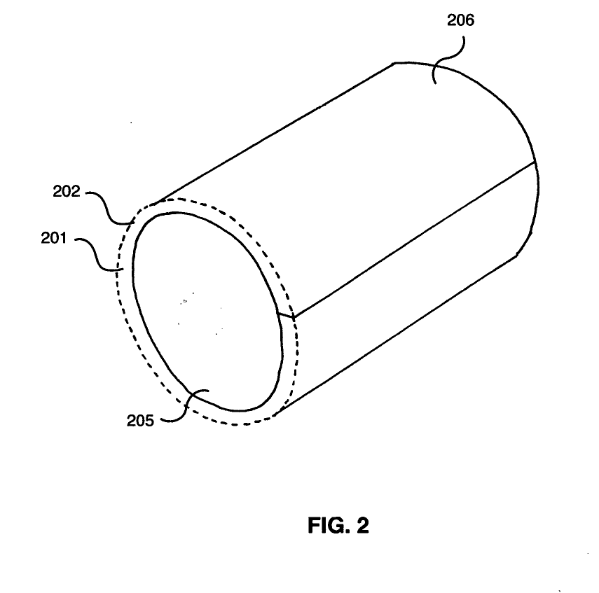

FIG. 2 is a single-view drawing according to an embodiment of the present invention. It comprises a generally battery cell and at least one of removable element. A generally battery cell in this example comprising a battery tube which is inside and not visible from outside; a negative cap 205 on the left side of battery tube; a positive cap on the right side of battery tube which is invisible; a battery jacket 206 coating on the top of battery tube and parts of both caps. Removable Element 201 is in this example an ending part of battery jacket 206 on the top of negative cap 205.

Removable Element 201 is in this example easy to be torn off by battery users along Dotted Line 202 to mark a status of battery cell. Ideally Removable Element 201 is green to instruct it is a good battery cell. After Removable Element 201 is removed, a battery cell without a green Removable Element means in this example that the battery is dead.

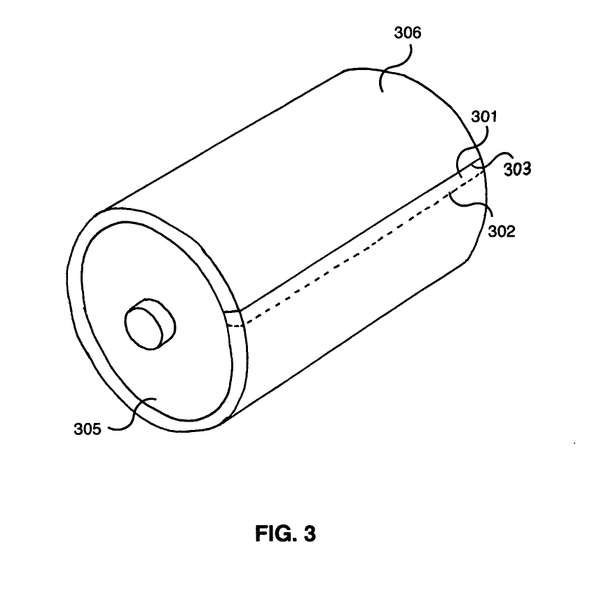

FIG. 3 is a single-view drawing according to an embodiment of the present invention. It comprises a generally battery cell and at least one of Removable Element. A generally battery cell in this example comprising a battery tube which is inside and not visible from outside; a positive cap 305 on the left side of battery tube; a negative cap on the right side of battery tube which is invisible; a battery jacket 306 coating on the top of tube and parts of both caps. Removable Element 301 is in this example an extended part of battery jacket 306 along its straight edge which currently is made to dotted line 302 connected to extended part removable element 301 with a new edge 303.

Removable Element 301 is in this example easy to be torn off by battery users along Dotted Line 302 to mark a status of battery cell. Ideally there is in this example text information around the Dotted Line 302 which instructs users how to use it. After Removable Element 301 is removed, a bumpy edge along the Dotted Line 302 will be formed which in this example inform users, including the blind, that battery cell is dead.

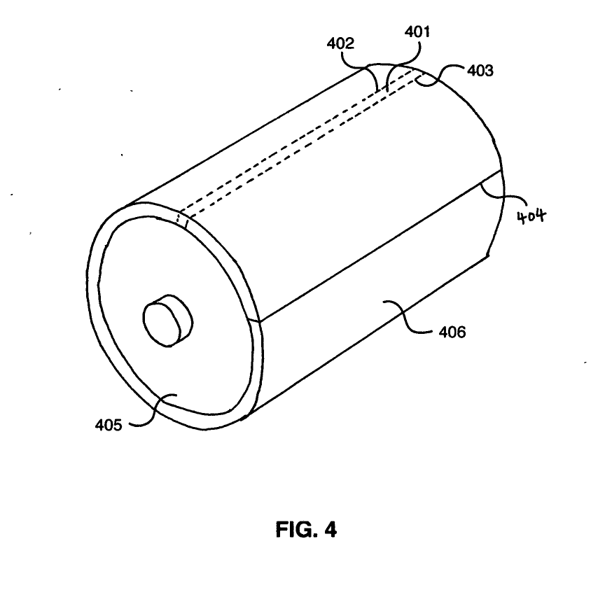

FIG. 4 is a single-view drawing according to an embodiment of the present invention. It comprises a generally battery cell and at least one of removable element. A generally battery cell in this example comprising a battery tube which is inside and not visible from outside; a positive cap 405 on the left side of battery tube; a negative cap on the right side of battery tube which is invisible; a battery jacket 406 coating on the top of tube and parts of both caps. Removable Element 401 is in this example a part of battery jacket 406 along the tube.

Removable Element 401 is in this example easy to be torn off by battery users along Dotted Line 402 and 403 to mark a status of battery cell. Ideally there is text information showed around Dotted Line 402 and 403 to instruct battery users how to use it. After Removable Element 401 is removed, another text information is visible to inform in this example that battery cell is bad.

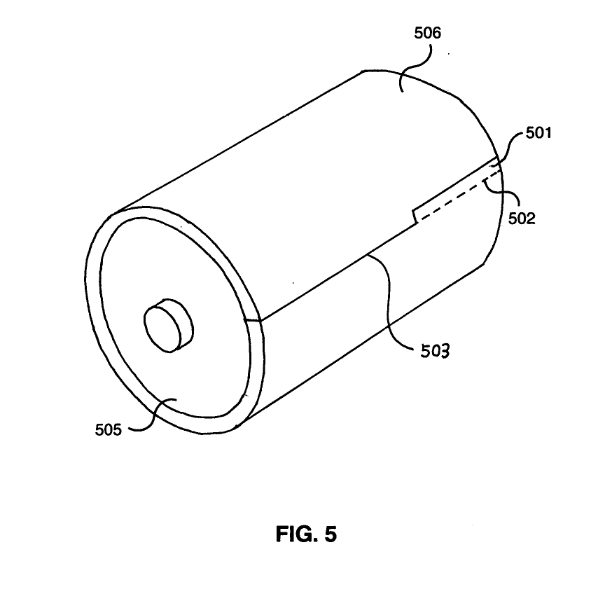

FIG. 5 is a single-view drawing according to an embodiment of the present invention. It comprises a generally battery cell and at least one of Removable Element. A generally battery cell in this example comprising a battery tube which is inside and not visible from outside; a positive cap 505 on the left side of battery tube; a negative cap on the right side of battery tube which is invisible; a battery jacket 506 coating on the top of tube and parts of both caps. Removable Element 501 is in this example an extended part of battery jacket 506 along its straight edge 503.

Removable Element 501 is in this example easy to be torn off by battery users along Dotted Line 502 to mark a status of battery cell. Ideally Removable Element 501 has text information around Dotted Line 502 in this example instructs users how to use it. After Removable Element 501 is removed, another text information is visible which in this example informs users that it's a bad battery.

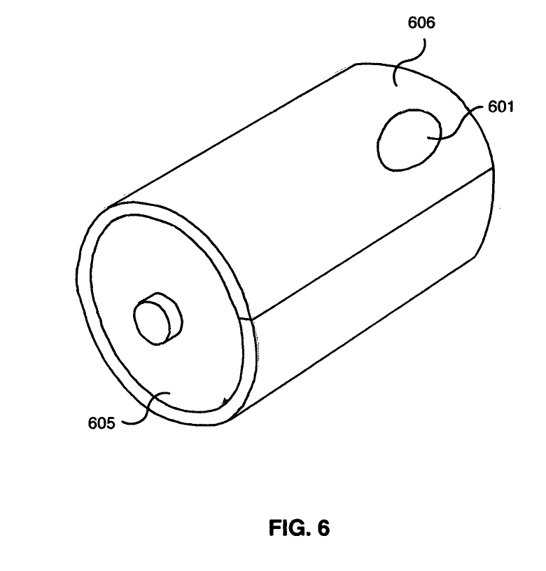

FIG. 6 is a single-view drawing according to an embodiment of the present invention. It comprises a generally battery cell and at least one of Removable Element. A generally battery cell in this example comprising a battery tube which is inside and not visible from outside; a positive cap 605 on the left side of battery tube; a negative cap on the right side of battery tube which is invisible; a battery jacket 606 coating on the top of tube and parts of both caps. Removable Element 601 is in this example an additional layer on the top of battery jacket 606.

Removable Element 601 is in this example easy to be peeled off or scratched off to mark a status of battery cell. After Removable Element 601 is removed, in this example an empty battery icon is visible which informs users that the battery is a bad one.

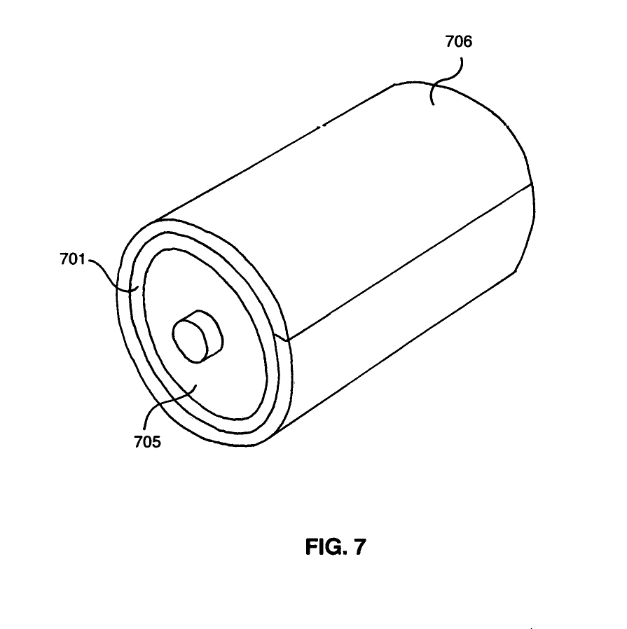

FIG. 7 is a single-view drawing according to an embodiment of the present invention. It comprises a generally battery cell and at least one of Removable Element. A generally battery cell in this example comprising a battery tube which is inside and not visible from outside; a positive cap 705 on the left side of battery tube; a negative cap on the right side of battery tube which is invisible; a battery jacket 706 coating on the top of tube and part of both caps. Removable Element 701 is in this example an additional layer on the top of cap 705.

Removable Element 701 is in this example easy to be peeled off or scratched off to mark a status of battery cell. After Removable Element 701 is removed, in this example a text information is visible which informs users that it's dead.

Although drawing sheets 1-7 are examples of cylindrical battery cells with jacket, the battery cell in present invention also could be other types battery cells with or without jackets.

It will be apparent to one with skill in the art that battery cells with marking function of the invention may be provided using some or all of the mentioned components without departing from the spirit and scope of the present invention. It will also be apparent to the skilled artisan that the embodiments described above are specific examples of a single broader invention which may have greater scope than any of the singular descriptions taught. There may be many alterations made in the descriptions without departing from the spirit and scope of the present invention.

1. A battery cell, comprising:
a) a generally cylindrical or cuboid battery cell;
b) one or more than one removable element
c) said removable element is on the surface of said battery cell;
d) said removable element provides a marking function.

2. The battery cell of claim 1 wherein said battery cell having surface comprising:
a) a positive cap on one side of said battery cell and a negative cap on another side of said battery cell;
b) a battery jacket coating on part of said battery cell;
c) said removable element extended from the ending edge of said battery jacket;
d) said removable element having information to indicate battery users to use it for marking purpose;
e) said removable element is combined with said battery jacket by one or more than one line;
f) said line enable battery users to tear off or peel off said removable element from said battery jacket;
g) a further information is visible after said removable element is removed;
h) said further information indicates at least one of status of battery cell;
i) said statuses of battery cell comprising: used; bad; good; full; empty.

3. The battery cell of claim 1 wherein said battery cell having surface comprising:
a) a positive cap on one side of battery cell and a negative cap on another side of battery cell;
b) a battery jacket coating on part of said battery cell;
c) said removable element is part of jacket or the whole jacket of said generally battery cell;
d) said removable element having information to indicate battery users to use it for marking purpose;
e) said removable element is combined with said battery jacket by one or more than one line;
f) said line enable battery users to tear off or peel off said removable element from said battery jacket;
g) the further information is visible after said removable element is removed;
h) said further information indicates one or more than one status of battery cell;
i) said statuses of battery cell comprising: used; bad; good; full; empty.

4. The battery cell of claim 2 and 3 wherein said line is pre-cut in a dotted/dashed line which enable battery users to remove said removable element; After remove said removable element; said line forming a bumpy edge so the blind by touching the bumpy edge are able to recognize it as the information indicating said at least one of status of battery cell.

5. The battery cell of claim 1 wherein said battery cell having surface comprising:
a) a positive cap on one side of battery cell and a negative cap on another side of battery cell;
b) a battery jacket coating on part of said battery cell;
c) said removable element is additional layer adhered to said surface of said battery cell;
d) said removable element having information to indicate battery users to use it for marking purpose;
e) said removable element is able to be torn off; peeled off or scratched off from said surface of battery cell;
f) the further information is visible after said removable element is removed;
g) said further information indicates one or more than one status of battery cell;
h) said statuses of battery cell comprising: used; bad; good; full; empty.

5. The battery cell of claim 1 wherein said battery cell having surface comprising:
a) a positive cap on one side of battery cell and a negative cap on another side of battery cell;
b) a battery box forming said battery cell;
c) said removable element is additional layer adhered to said surface of said battery box;
d) said removable element having information to indicate battery users to use it for marking purpose;
e) said removable element is able to be torn off; peeled off or scratched off from the body of battery;
f) the further information will be showed to the battery user which originally is covered by said removable element after it is removed;
g) said further information indicates one or more than one status of battery;
h) said statuses of battery comprising: used; bad; good; full; empty.

6. The battery cell of claim 2 and 3 wherein said lines are pre-cut in a dotted line or dashed line; Said dotted line or dashed line enable said removable elements removable;

7. The battery cell of claim 6 wherein said dotted line or dashed line forming bumpy edge; said bumpy edge enable the blind to recognize one or more than one said status of said battery cell.

8. The battery cell of claim 2, 3, 4 and 5 wherein said information of status are embodied by colour; text; images and signs.
